(19) United States
(12) Patent Application Publication
(10) Pub. No.: US 2006/0082922 A1
(43) Pub. Date: Apr. 20, 2006

(54) Trajectories-based seek

(76) Inventor: Teng-Yuan Shih, San Jose, CA (US)

Correspondence Address: Teng - Yuan Shis, 1197 Valley Quail Circle, San Jose, CA, 95120, US

(21) Appl. No.: 10/966,670

(22) Filed: Oct. 15, 2004

(51) Int. Cl. G11B 5/596

(52) U.S. Cl. 360/78.06; 360/78.09

(57) ABSTRACT

A hard disk drive moves a transducer across a disk surface so that the transducer has an acceleration trajectory, which is symmetric about the midpoint of the curve. A digital signal processor known as a controller is used to control the movement of a transducer. The function of a controller is to move the transducer from its present track to a target track in accordance with a servo control routine. During the seek routine the controller moves the transducer in accordance with seek trajectories derived from a design waveform. The seek trajectories are generated at real time for the controller to perform its function. The invention addresses two important features of trajectories-based seek servomechanism. A very general class of waveforms is the prototype acceleration of investigation, which includes the known waveforms of prior art as its special cases, including the classical bang-bang control, simple sinusoidal seek, more sophisticated generalized Fourier seek trajectory or even the very versatile trajectories such as extended sinusoidal waveform and the generalized sinusoidal waveform. The method of generating seeks trajectories based on a general, normalized waveform is devised. The method is universally applicable for a general waveform, which has symmetry property about its midpoint. The generation of seek states at real time is generally a tedious task. One method for the sinusoidal seek method uses recursive approach to update seek states with the use of trigonometric identities. The extension of this recursive method applies to the generalized Fourier seek trajectory. Following the same lines of recursive method with use of trigonometric identities, more tedious recursive methods can be used for either the extended sinusoidal waveform or the generalized sinusoidal waveform. However, it is much simpler and effectively to use a multi-linear approximation for any seek trajectory to generate seek states for controller. The benefit of the multi-linear approximation over the recursive method becomes even more pronounced when the waveform gets more complicated.

### BACKGROUND OF THE INVENTION

1. Field of the Invention

The present invention relates generally to the design of an apparatus for implementing a very general class of waveform for seek control of servo system associated with a hard disk drive. For use as a current profile in seeks, the general waveform for acceleration trajectory possesses the property of symmetry about its midpoint. Specifically, the invention devises a method to utilize an arbitrary waveform, which is normalized in both amplitude and period to generate seek trajectories, including acceleration, velocity and position for a seek controller to move transducer (or recording head) of a hard disk drive from its present position to another position. The controller forces the movement of a transducer to follow the design trajectories of motion during the process of seeks for better seek performance.

2. Background

Hard disk drives include a plurality of magnetic transducers that can write and read information by magnetizing and sensing the magnetic field of a spinning disk(s), respectively. The information is typically formatted into a plurality of sectors that are located within an annular track. There are a number of tracks located across each surface of the disk. A number of vertically aligned tracks are usually referred to as a cylinder.

Each transducer is integrated into a slider that is incorporated into a head gimbal assembly (HGA), which is referred to as a head or recording head in the following. Each HGA is attached to an actuator arm. The actuator arm is actuated by a voice coil motor (VCM), which is attached to the actuator assembly, and is composed of a coil and a magnetic circuit device. The hard disk drive typically includes a driver circuit and a controller that provide current to excite the VCM in accordance with a servo algorithm. The excited VCM rotates the actuator arm and moves the heads (or, synonymously, transducers) across the surfaces of the disk(s). When writing or reading information the hard disk drive performs a seek routine to move a head (transducer) from one track to its target track on a disk surface. The controller performs a servo routine to assure the transducer moves to the target position fast and accurately.

Prior art of seek control includes two major seek trajectories as waveform for current profile. They are bang-bang control trajectory and standard sinusoidal trajectory. Many disk drive designs utilize a bang-bang control algorithm for the servo routine to move the transducers because the bang-bang trajectory is theoretically the time optimal method. The waveform of the bang-bang current profile is a positive square wave followed by another square wave in opposite direction. A sinusoidal wave as current profile has been used as an alternative for a bang-bang trajectory of seeks control. A standard sinusoidal seek trajectory is simply a sine function with seek-length dependent period. A sinusoidal waveform is very rigid because there is no flexibility for any changes.

To get around the rigidity issue of the sinusoidal seek method, there is an approach of prior art to generate an acceleration trajectory with a constant acceleration phase by employing a Fourier series representation with a very few terms. Special efforts are made to eliminate the well-known Gibbs phenomenon of classical Fourier analysis in the trajectory. The approach is named a generalized Fourier seek method because it is not an ordinary Fourier series. An optimization method exists in prior art to determine coefficients for the generalized Fourier waveform by minimizing the total mean-square error.

As an alternative to the generalized Fourier seek method, there is a method of the prior art that uses the extended sinusoidal trajectory (FIG. 1) for seek servomechanism, which works directly on the geometry of the sinusoidal waveform to insert a constant phase of acceleration for faster access time. The extended sinusoidal waveform is constructed by saturating the sinusoidal wave at a specified level smaller than unity. The resulting waveform is then normalized to have unit amplitude. The method is very general and flexible for adjusting the duration of constant acceleration phase in the waveform.

The generalized sinusoidal waveform (FIG. 2) is another class of trajectories generated by directly modifying the sine function of the prior art. Both the waveform and its derivative (slope) of a generalized sinusoidal profile are continuous at every point on the trajectory. The generalized sinusoidal waveform is constructed by modifying directly on the simple sine function with the insertion of a constant acceleration phase at the maximal and minimal points of the sine wave. For a standard sinusoidal waveform, the positive portion corresponds to the acceleration phase and the negative portion associates with the deceleration phase. Either the acceleration phase or the deceleration phase of the sinusoidal waveform can be further divided into two sub-phases depending on the slope of the waveform. The acceleration phase can be divided into the initial acceleration phase when the slope of waveform is positive and the final acceleration phase when the slope of the waveform is negative. The boundary point between the initial and final acceleration phases is the peak of acceleration. Similarly, we can divide the deceleration phase into the initial deceleration phase and the final deceleration phase depending on the sign of the waveform slope. The boundary point between the initial and final deceleration phases is the peak of the deceleration phase. The generalized sinusoidal waveform is constructed by inserting a constant acceleration phase in between the initial acceleration phase and the final acceleration phase and also inserting a constant deceleration phase in between the initial deceleration phase and the final deceleration phase. The total duration of the resulting generalized sinusoidal waveform is then normalized to have unity period. The waveform generated from such a construction method is equivalent to extend the peak of acceleration from a point to a finite duration and to extend the peak deceleration from a point to an equal-length finite duration. The only restraint of the trajectory is that the constant duration for acceleration and deceleration shall not exceed one half of the total duration of the waveform.

The waveforms of the prior art are used to generate seek trajectories for controller, which performs a servo routine to move a transducer across disk surface. The waveform is used as the current trajectory for VCM with its amplitude determined by maximum current level of system design. The acceleration trajectory is linearly proportional to the current trajectory. The direct integration of the acceleration with respect to time for one time and two times yield the velocity trajectory and position trajectory, respectively. To perform its design function, the controller requires the information of current, velocity and position at any instant of servo interrupt during the entire process of seeks. Therefore, the computation of seek trajectories at any instant of time is essential for servomechanism design. The computation of seek trajectories is, therefore, an important task that should be carries out fast and accurately on real time basis. The trajectories for bang-bang control are easy and straightforward to generate. One method to generate sinusoidal seek trajectories employs a recursive algorithm with the use of trigonometric identities to calculate future values (synonymously, states) of these trajectories from their initial values (or states). The generation of seeks trajectories for the generalized Fourier seek method uses a similar recursive approach, which is significantly more tedious because, at least, one more harmonic term is involved. The seek trajectories for the extended sinusoidal waveform and the generalized sinusoidal waveform can be generated following the lines of trigonometric manipulations of even more complicated operations. Much more tedious real-time computations are necessary to generate states for these trajectories. High power central processing unit (CPU) as the digital signal processor (DSP) for the controller is necessary. It is important to emphasize that the states of trajectories are calculated on real time basis, and they need to be calculated fast and accurately. Therefore, it is crucial to come out with an effective method for generating states of seek trajectories at real time. The invention devises an algorithm for the computations of seek states of trajectories at real time using multi-linear approximations for trajectories. Compared to the recursive method for updating states, the new method is a much simpler approach to generate seek trajectories at real time.

3. Objects and Advantages

The invention addresses the usage and method of a very general class of waveform for current profile in seek servomechanism of hard disk drives. This general class of waveform is very general and flexible. It includes not only the conventional seek waveforms of bang-bang control curve and the sinusoidal waveform but also the more general waveforms such as the extended sinusoidal waveform and the generalized sinusoidal waveform as its special cases. The class of general waveform requires that the waveform be symmetric about the midpoint of the trajectory (FIG. 3) because it simulates the acceleration phase and deceleration phase of current profile in a seek process.

Using a waveform as acceleration profile, it is necessary to generate seek trajectories, including current trajectory, velocity trajectory and position trajectory at any instant of servo interrupt during a seek process. For generality, a waveform is typically normalized. The waveform is normalized for both amplitude and period. A normalized waveform is representative for any seek length. Based on the waveform, the velocity trajectory and position trajectory are derived. Both the velocity trajectory and the position trajectory are normalized so that they have unity amplitude in addition to unity period. For a short to medium seek length, an acceleration profile (or current profile) consists two phases: acceleration phase and deceleration. For a relatively longer seek length, the velocity of a transducer in the seek process may exceed a threshold design velocity limit, which is set to assure that the transducer can reliably read system information of Gray code from disk surface. Therefore, a coast mode is inserted in between the acceleration mode and the deceleration mode in which the current is set to be zero. Depending on the seek length, the duration of coast mode varies.

The seek trajectories are typically generated for seeks without coast mode because the duration of coast mode can be different. For a selected waveform, the first step to generate seek trajectories is to determine the maximum seek length without a coast mode and the corresponding maximum seek time. The threshold seek length is dependent on both the hardware design such as torque constant and moment of inertia of actuator arm and geometrical layout of actuator arm, transducer and disk. When a seek length is longer than the threshold seek length, the duration of coast mode is determined based on the limit speed. The trajectories of long seeks with coast mode are formulated based on the normalized acceleration waveform. The acceleration mode and deceleration mode of trajectories are separated by a seek length dependent coast mode. The deceleration mode trajectories are essentially the same as those without coast mode with the exception of phase delay. When the seek length is shorter than the threshold seek length, we have to compute the seek time for the given seek length first. The seek time is proportional to a waveform dependent parameter and the square root of seek length. The seek trajectories for such seeks without coast mode are then formulated with appropriate scaling of time axis and the amplitudes of trajectories.

Since the information of seek trajectories are required for the seek controller to perform its function, it is important that the seek states are generated effectively at real time. The curve of seek time versus seek length is approximated by a piecewise linear curve. By dividing this seek time versus seek length curve into a few segments and storing the end points with associated slope in system memory, the seek time is extracted from an appropriate segment by linear interpolation method. Similarly, the seek trajectories, including current, velocity and position, are modeled using a multi-linear approximation. Each trajectory is divided into a few segments with the number and density of segments determined by local curvatures of each trajectory. At any instant of servo interrupt, the seek states for current, velocity and position are extracted from a separate appropriate segment of each trajectory. Using the multi-linear approximation for either a seek time curve or any of the three seek trajectories is simpler and more computationally efficient than the conventional approach using recursive method to update seek states with trigonometric identities. The benefit of the method of multi-linear approximation for a design curve is especially more noticeable when the acceleration waveform gets more complicated.

### SUMMARY

To write to or to retrieve information from a target position on disk surface, a recording transducer of an actuator arm assembly moves to the target track on disk surface following a command from controller. The controller uses a servo routine to generate current for VCM as an engine to move the transducer to target reliably and as fast as possible. A bang-bang control algorithm for VCM current has been popular because it is theoretically time optimal for seek time. Since there are a few drawbacks associated with the bang-bang control, a sinusoidal seek method has been used as a preferred alternative to bang-bang control. The sinusoidal function has its merits; however, its waveform is rigid, and the only way to improve seek time is to increase the amplitude of the sinusoidal waveform that is not always possible. To improve the seek time associated with the sinusoidal waveform, a generalized Fourier seek method coupled with an optimization method to determine coefficients for its ingredient harmonics generates a class of more general waveform for seeks. To use the seek trajectories generated based on a current profile, the seek controller needs to know the states (or values) of current, velocity and position at any instant of servo interrupt, which implies that one has to compute these states of trajectories at real time basis. Except the bang-bang control that has relatively simple trajectories, the computation of seek trajectories for other waveform is a time consuming and tedious task even for today's powerful digital signal processor. A recursive method using trigonometric identities has been used to update seek states of trajectories associated with the sinusoidal seek method. Following the same lines of trigonometric manipulations, a more tedious recursive method is used to generate trajectories for generalized Fourier seek method. With the devises of new classes of waveforms for better seek time and robustness performance such as the extended sinusoidal waveform and the generalized sinusoidal waveform, the computation of these trajectories at real time using the recursive method and its likes may be a formidable task for its poor efficiency.

The invention addresses the implementation method for a very general class of waveforms for seek controls, including the formulation of seeks trajectories based on an arbitrary acceleration waveform and the computation method to generate the states of seek trajectories at real time. The new class of waveforms is very general, and its only restraint is that the waveform is symmetric about the midpoint of the curve for emulating a typical seek process with the acceleration mode coming first and followed by a deceleration mode. The general class of waveforms includes the bang-bang control, the sine function, the generalized Fourier waveform or even the more general extended sinusoidal waveform and the generalized sinusoidal waveform as its special cases under different restraints.

For generality, a waveform is typically normalized. The waveform is normalized for both amplitude and period. A normalized waveform is representative for any seek length. The formulation of seek trajectories from a normalized acceleration waveform is not a trivial matter. Based on the waveform, the velocity trajectory and position trajectory are derived. Both the velocity trajectory and the position trajectory are normalized too. For a short to medium seek length, an acceleration profile (or current profile) consists two phases: acceleration phase and deceleration. For a relatively longer seek length, the velocity of a transducer in the seek process may exceed a threshold velocity, which is set to assure that the transducer can reliably read Gray code from disk surface. Therefore, a coast mode is inserted in between the acceleration mode and the deceleration mode. Depending on the seek length, the duration of coast mode varies. For any given waveform, we have to compute the maximum seek length without coast mode and its associated seek time, which are dependent on both the hardware design and the geometrical layout of drives. The design procedures to obtain these two threshold design parameters are outlined. When seek length is shorter than the threshold seek length, the coast mode is not present, and the seek time is proportional to a waveform-dependent parameter and the square root of a seek length. To account for the inflexibility of square-root operation using a fixed-point processor, a multi-linear approximation for the seek time versus seek length is used to extract the seek time for a given seek length, based on which we formulate seek trajectories from the normalized acceleration waveform. When the seek length is longer than the threshold seek length, a coast mode exists. The duration of coast mode is determined, and the coast mode is inserted in between the acceleration mode and the deceleration mode. The trajectories of the deceleration mode are essentially the same as the case of trajectories without coast mode with the exception of phase delay.

After the completion of formulating seek trajectories for a given waveform, one has to implement these trajectories by generating seek states at any time instant of servo interrupt at real time. Instead of using the conventional recursive method to update the seek dates, we find that it is less time consuming and more efficient to compute seek states by approximating each seek trajectory with a piecewise linear curve, and the seek state at any instant is extracted from an appropriate segment. The benefit of the multi-linear approximation becomes even more pronounced when the waveform gets more complicated.

### DRAWINGS

FIG. 1 illustrates the method to generate an extended sinusoidal waveform. The waveform is constructed by saturating a sine function at a specified level 0<p<1. The resulting waveform is then normalized so that it has unity amplitude. This waveform is a special case of the general waveform investigated in the patent.

FIG. 2 presents the generation method for a generalized sinusoidal waveform Inserting a constant acceleration range and constant deceleration range to a sine function generates the waveform. Both the waveform and its slope are continuous. This waveform is a special case of the general waveform investigated in the patent.

FIG. 3 depicts typical waveform of the general trajectory class, which is symmetrical about the midpoint of the waveform. This general waveform is very versatile provided that it is symmetric about its midpoint.

FIG. 4 shows examples of the same waveforms of FIG. 3 with a duration of coast mode.

FIG. 5 is a flowchart summarizes the procedures to generate seek trajectories. For a given seek length, the flowchart shows step-by-step procedures to determine whether a coast mode exists and to generate the final forms of seek trajectories.

FIG. 6 shows a controller with parametric seek trajectories. The controller requires the information of current, velocity and position at any instant of sampling time during seeks.

FIG. 7 is an illustration of a controller design with seek trajectory on phase plane. The controller needs information of current trajectory and the seek trajectory on the phase plane at any instant of sampling time during seeks. The seek trajectory on phase plane is obtained combining the velocity and position trajectories by eliminating the time parameter explicitly.

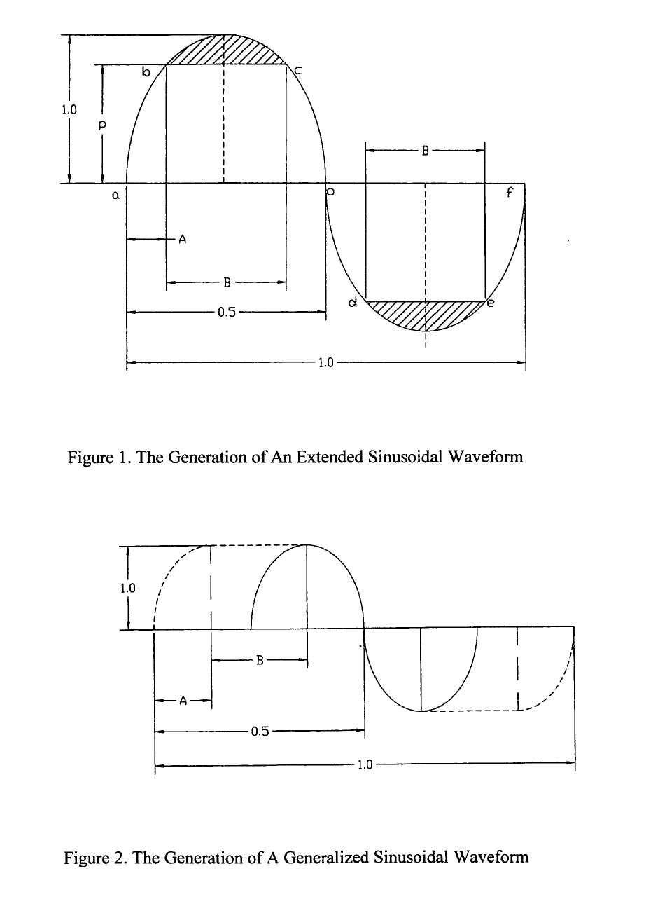

### DETAILED DESCRIPTION

1. Acceleration Waveform and Seek Trajectories

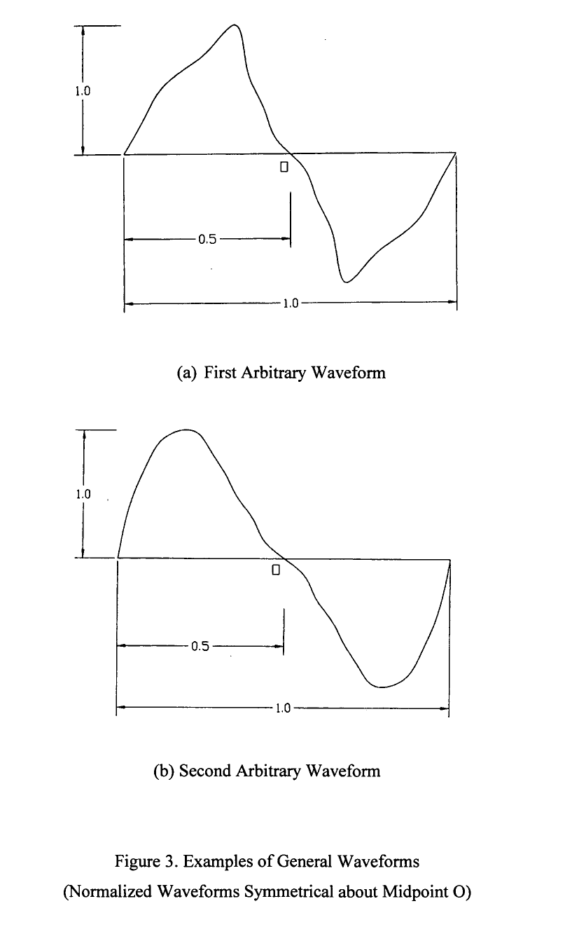

The waveform as acceleration trajectory in the patent is very general, which is usually normalized for both the abscissa and coordinate of the curve. The abscissa of the trajectory is the normalized time. The coordinate of the trajectory is the normalized acceleration. The normalized acceleration waveform is arbitrary as long as it is symmetric about the midpoint of the trajectory (FIG. 3). Generally, the acceleration waveform is designed based on performance considerations such as access time, acoustic level, power consumption etc.

In general form, the acceleration trajectory can be described by the following equation.

$$a ( x ) = \{ \begin{matrix}f ( x ) , & 0 \leq x < \frac{1}{2} , \\ - f ( x - \frac{1}{2} ) , & \frac{1}{2} < x \leq 1.\end{matrix} \qquad ( 1 )$$

Note that f(x) in Eq. (1) defined in

$$0 \leq x < \frac{1}{2}$$

should be continuous inside the range.

The general normalized acceleration trajectory also satisfies the following restraint.

$${max}_{0 \leq x \leq 1} a ( x ) = 1 \qquad ( 2 )$$

For servo design of seek control for hard disk drive applications, we need four seek trajectories at any instant of servo interrupt during the entire process of seeks. These seeks trajectories are current trajectory, acceleration trajectory, velocity trajectory and displacement (or position) trajectory. The current trajectory is directly proportional to the given acceleration trajectory. For any given acceleration waveform a(x), the corresponding velocity waveform v(x) and displacement waveform d(x) can be obtained using any of the following four methods.
(1) Analytical method: The velocity trajectory and displacement are directly obtained from the acceleration trajectory by integrating with respect to time once and twice, respectively. Dividing by the maximum value of each trajectory normalizes each trajectory after the integration. These normalized trajectories for velocity and position are shown in the following.

$$\begin{matrix}v ( x ) = \frac{{\int }_{0}^{x} a ( {x}_{1} ) ⅆ {x}_{1}}{{\int }_{0}^{\frac{1}{2}} a ( {x}_{1} ) ⅆ {x}_{1}} & ( 3 ) \\ d ( x ) = \frac{{\int }_{0}^{x} v ( {x}_{1} ) ⅆ {x}_{1}}{{\int }_{0}^{1} v ( {x}_{1} ) ⅆ {x}_{1}} & ( 4 )\end{matrix}$$
The denominators of integrals in Eq. (3) and Eq. (4) are used to normalize the resulting trajectories. The denominator in Eq. (3) is the maximum velocity of the velocity trajectory before normalization. Similarly, the denominator in Eq. (4) is the maximum position of the position trajectory before normalization. The analytical method evaluates the trajectories of Eq. (3) and Eq. (4) in closed form.
(2) Numerical method: The trajectories of velocity and displacement trajectories are obtained from Eq. (3) and Eq. (4) by numerical integration method. Although there are no closed form representations available, v(x) and d(x) are directly available for code implementation.
(3) Instrumental method: For a given design acceleration trajectory a(x), the corresponding velocity and displacement trajectories are obtained using whatever instrument for calculating the area under the curves.
(4) Experimental method: Since the acceleration trajectory is linearly proportional to the current input of VCM, the velocity trajectory and displacement trajectory can be directly measured.
A very different waveform may be devised in the future to servo certain specific purposes of seek servomechanism in the future. The waveform is likely to be very different from the waveforms we know today. For such a waveform, the seek trajectories of velocity and position are likely to be obtained by using any of the latter three methods but not the analytical method.

In Eq. (3), the denominator

$${\int }_{0}^{\frac{1}{2}} a ( {x}_{1} ) ⅆ {x}_{1}$$

is applied for normalization so that the maximum value of v(x) is 1 in the range of 0≦x≦1. Similarly, the denominator ∫₀¹v(x₁)dx₁ in Eq. (4) is applied for normalization so that the maximum value of d(x) is 1 in the range of 0≦x≦1.

Under the restraint of Eq. (1), the general function a(x) satisfies the following equation.
∫₀¹a(x)dx=0 (5)

Eq. (5) states that the total area under the acceleration trajectory is zero.

The simplest trajectory of the general waveform class is a bang-bang acceleration curve, which is a square wave for the first half of period followed by a negative square wave with the same magnitude for the second half of the period. A sinusoidal waveform is another example of the general waveform class, which is a simple sine function defined by a(x)=sin(x). For either of these waveforms, the corresponding velocity trajectory and displacement trajectory are readily obtained in closed forms by direct integrations.

There are, at least, two more complicated seek trajectories of the prior art that are devised for seek control for hard disk drives. By saturating the sine function at a specified level less then one, and the resulting waveform is normalized to have unit amplitude, the extended sinusoidal waveform is constructed. To generate a generalized sinusoidal waveform, a constant acceleration phase and a corresponding constant deceleration phase are inserted at the peaks of the standard sine function, and the resulting waveform is normalized to have unit period. The normalized seek trajectories including acceleration, velocity and displacement using either the extended sinusoidal waveform or generalized sinusoidal waveform of prior art as design current profile exist. However, the implementation method for these seek trajectories is not a trivial matter. The invention outlines the method and procedure to implement the seek trajectories of the most general forms, which apply not only to simple waveform such as the sine function but also to more complicated waveforms such as the extended sinusoidal waveform and the generalized sinusoidal waveform. Furthermore, the implementation method applies for any acceleration waveform that satisfies Eq. (1).

The waveform of the acceleration trajectory is usually normalized for the normalized time in the range 0≦n*≦1. However, the seek trajectories required for the controller are defined in the range of 0≦n≦N_{SK}, where n is the discrete sampling time and N_{SK} is the seek time for a given seek length. The normalized time n* is related to the actual time by the following relationship.

$${n}^{*} = \frac{n}{{N}_{SK}} \qquad ( 6 )$$

For physical applications of the normalized waveform, the time axis of the waveform will be stretched, which is achieved by scaling the normalized time axis by seek time N_{SK}.

Let gₐ(n) denote the physical acceleration trajectory defined in the range of 0≦n≦N_{SK}. Further, assume that the function gₐ(n) satisfies the restraint of Eq. (2) for simplicity. Considering a seek length without coast mode for now, we have
gᵥ(N_{SK})=∫₀^{N}^{_{SK}}gₐ(n)dn=N_{SK}∫₀¹gₐ(nN_{SK})dn≡N_{SK}∫₀¹a(n)dn=0 (7)

The integral given above is the total area under the curve, which is the final velocity at the end of seek. The integral of Eq. (7) is equal to zero because the velocity diminishes at the end of seek. Since the initial velocity is zero, we have gᵥ(0)=0 as implied by Eq. (7). In Eq. (7), a(n) is a mathematical acceleration trajectory, which has been normalized for time axis and also amplitude as defined in Eq. (1). Making an integration from the start of a seek until a certain sampling instant n, the above equation becomes a corresponding velocity trajectory gᵥ(n) defined in the range of 0≦n≦N_{SK}.

$$\begin{matrix}{g}_{v} ( n ) = {\int }_{0}^{n} {g}_{a} ( {n}_{1} ) ⅆ {n}_{1} \\ = {N}_{SK} {\int }_{0}^{\frac{n}{{N}_{SK}}} {g}_{a} ( {n}_{1} {N}_{SK} ) ⅆ {n}_{1} \\ ≡ {N}_{SK} {\int }_{0}^{\frac{n}{{N}_{SK}}} a ( {n}_{1} ) ⅆ {n}_{1}\end{matrix} \qquad ( 8 )$$

As implied by Eq. (1), the velocity trajectory gᵥ(n) reaches its maximum at

$$n = \frac{{N}_{SK}}{2} ,$$

which is

$${max}_{0 \leq x \leq {N}_{SK}} {g}_{v} ( n ) = {N}_{SK} {\int }_{0}^{\frac{1}{2}} a ( n ) ⅆ n \qquad ( 9 )$$

Similarly, the displacement trajectory defined in the range of 0≦n≦N_{SK} is obtained from the acceleration trajectory by integrating twice.

$$\begin{matrix}{g}_{d} ( n ) = {\int }_{0}^{n} {\int }_{0}^{{n}_{2}} {g}_{a} ( {n}_{1} ) ⅆ {n}_{1} ⅆ {n}_{2} \\ = {( {N}_{SK} )}^{2} {\int }_{0}^{\frac{n}{{N}_{SK}}} {\int }_{0}^{\frac{{n}_{2}}{{N}_{SK}}} {g}_{a} ( {n}_{1} {N}_{SK} ) ⅆ {n}_{1} ⅆ {n}_{2} \\ ≡ {( {N}_{SK} )}^{2} {\int }_{0}^{\frac{n}{{N}_{SK}}} {\int }_{0}^{\frac{{n}_{2}}{{N}_{SK}}} a ( n ) ⅆ {n}_{1} ⅆ {n}_{2}\end{matrix} \qquad ( 10 )$$

Equivalently, the displacement trajectory g_{d}(n) defined in the range of 0≦n≦N_{SK} can be shown as a one time integration of a velocity trajectory gᵥ(n) defined in the same range of n.

$$\begin{matrix}{g}_{d} ( n ) = {\int }_{0}^{n} {g}_{v} ( {n}_{1} ) ⅆ {n}_{1} \\ = {N}_{SK} {\int }_{0}^{\frac{n}{{N}_{SK}}} {g}_{v} ( {n}_{1} {N}_{SK} ) ⅆ {n}_{1} \\ ≡ {N}_{SK} {\int }_{0}^{\frac{n}{{N}_{SK}}} v ( {n}_{1} ) ⅆ {n}_{1}\end{matrix} \qquad ( 11 )$$

The function v(n) in Eq. (11) is a normalized velocity trajectory as defined in Eq. (3).

Eq. (11) implies that the initial position is g_{d}(0)=0 and the maximum displacement is just the final position given by
g_{d}(N_{SK})=N_{SK}∫₀¹v(n)dn (12)

It is noted that the factor of N_{SK} appears in Eq. (8) for the velocity trajectory and the factor of (N_{SK})² associated with the displacement trajectory of Eq. (10).

The result of Eq. (10) is important in the determination of maximum seek length without coast mode for any given waveform.

The current trajectory i(x) and the acceleration trajectory is related by the following equation.

$$a ( x ) = \frac{{K}_{T}}{J} i ( x ) \qquad ( 13 )$$

Since the actuator arm has a rotary motion in modem hard disk drive design, the acceleration a(x) given in Eq. (13) is angular acceleration shown in the unit of radian/sec². The two symbols of K_{T} and J in Eq. (13) stand for VCM torque constant and mass moment of inertia of the actuator arm, respectively.

2. Maximum Seek Length Without Coast Mode

The moving speed of a transducer is typically set to a limit so that the transducer can read system information such as Gray code from disk surface reliably. There is coast mode in the acceleration trajectory for short to medium seek lengths. When the seek length is relatively long, and the maximum velocity based on the design acceleration trajectory may exceed the limit speed, a coast mode is inserted in the middle of the acceleration trajectory, in which the acceleration is set to be zero. During the coast mode, the transducer is cruising at a constant speed that is the design limit speed.

The maximum seek length without a cost mode is dependent on three factors. The first factor is the design related parameters such as torque constant, inertia of actuator arm, maximum VCM current, arm length etc. The second factor is the design limit speed of transducer. Finally, the acceleration waveform is a critical factor for determining the maximum seeks length without a coast mode. The more aggressive the acceleration waveform, the shorter the maximum seek length without a coast mode.

Given an acceleration waveform, the first task is to determine the maximum seeks length without a coast mode or threshold maximum seek length and the corresponding seek time or threshold maximum seek time for implementation of seek algorithm. The threshold seek time is generally determined first, then the threshold maximum seek length is calculated accordingly.

To present the concept of the invention, a reference design is made. The design parameters related to the generation of seek trajectories are summarized in Table 1 below.

TABLE 1
Parameters of Reference Design

| | | Numerical | | |
|---|---|---|---|---|
| No | Parameter | Value | Unit | Remark |
| 1 | Iₘₐₓ | 600 | mA | Maximum VCM current |
| 2 | K_{T} | 609.4 | gmf-cm/A | VCM torque constant |
| 3 | J | 27.00 | gm-cm² | Inertia of actuator |
| | | | | arm assembly |
| 4 | Lₐᵣₘ | 1.837 | in | Arm length (pivot to |
| | | | | transducer) |
| 5 | Vₘₐₓ | 95 | ips | Maximum speed (inch |
| | | | | per second) |
| 6 | Nₜᵣₖ | 133,932 | track | Total number of servo |
| | | | | tracks |
| 7 | Ψ | 29.5 | degree | Total data stroke |
| 8 | Ω | 7200 | RPM | Rotational speed of |
| | | | | spindle motor (Revolu- |
| | | | | tion per minute) |
| 9 | Nₛ | 240 | sector | Number of servo sectors |
| | | | | on a track |

The sinusoidal waveform is a limiting waveform for either the generalized sinusoidal waveform or the extended sinusoidal waveform when the duration of constant accelerations shrinks to zero. Let A denote the normalized duration for the initial acceleration phase, which is equal to the duration of final acceleration phase, initial deceleration phase or final deceleration phase. When there is no constant acceleration phase, we have the relationship that 4A=1.

Since the acceleration trajectory for seeks is normalized, the seek trajectories generated based on this normalized profile have to be converted to actual trajectories based on the design of consideration.

The procedures for trajectories design including the calculation of the threshold maximum seek length and corresponding seek time for a normalized acceleration waveform are as follows.
1. Calculate the maximum velocity associated with the normalized velocity trajectory for a seek, which is

$${v}_{max} = \frac{{K}_{T} {I}_{max}}{J} {\int }_{0}^{\frac{1}{2}} a ( x ) ⅆ x \qquad ( 14 )$$
In Eq. (14), a(x) is the normalized acceleration trajectory of design defined in the range of 0≦n≦1. The integral term represents the maximum velocity associated with the given acceleration trajectory, which is usually computed numerically even with the availability of solution in closed form. The factor (K_{T}Iₘₐₓ/J) represents the current amplitude of a actual design, where I_{MAX} is the maximum VCM current of system design.
2. Calculate the maximum seek time (in sample) for the longest seek length without coast mode.

$${N}_{max} = \frac{{V}_{max}}{{v}_{max} {L}_{arm} {T}_{S}} \qquad ( 15 )$$
3. Calculate the conversion factor of angular displacement (in radian) to track.

$${f}_{A2T} = \frac{{N}_{trk}}{Ψ} \frac{180}{π} \qquad ( 16 )$$
4. Finally, calculate the maximum seek length (in track) without a coast mode as follows.

$${X}_{max} = \frac{{K}_{T} {I}_{max}}{J} {{f}_{A2T} ( {N}_{max} {T}_{S} )}^{2} {\int }_{0}^{1} v ( x ) ⅆ x \qquad ( 17 )$$
The integral term in Eq. (17) represents the maximum displacement associated with the normalized velocity trajectory v(x), which is usually computed numerically even with the availability of solution in closed form. The presence of the (NₘₐₓT_{S})² in Eq. (17) follows directly from the reasoning given in Eq. (10).
5. When a given seek length X_{SK} is shorter than Xₘₐₓ, carry out the procedure from Step 6 through Step 10. Otherwise, one is ready to generate trajectories for a seek with coast mode. The method to generate these trajectories is described in Section 4.
6. Calculate the maximum position, which is the position at the end of seek, d_{f}=d(1.0) given by
   d_{f}=d(1.0)=∫₀¹v(x)dx (18)
In Eq. (18), x=1.0 is the end time for seek and v(x) is the normalized velocity trajectory given in Eq. (3). The final displacement is usually evaluated numerically except for very simple cases
7. Calculate the seek waveform dependent parameter for seek time ψ, which is defined as follows.

$$ψ = \frac{1}{\sqrt{{d}_{f}}} \qquad ( 19 )$$
This is a parameter representing the relative speed of seek time.
For the waveform of a sine function, we have ψ=\sqrt{2}π. For a bang-bang control curve, this parameter turns out to be ψ=2π.
For almost all practical waveforms, the parameter ψ falls in the range between the two limits defined by the sinusoidal waveform for the upper limit and the bang-bang control curve for the lower limit.
   2≦ψ≦\sqrt{2}π (20)
8. Calculate sampling time of the digital servo system as below.

$${T}_{S} = \frac{60}{{N}_{S} Ω} \qquad ( 21 )$$
9. Calculate the waveform dependent seek time (N_{SK}) as a function of seek length (X_{SK}) which is shorter than Xₘₐₓ.

$${N}_{SK} = ψ \frac{1}{{T}_{S}} \sqrt{\frac{J}{{K}_{T} {I}_{max}} {X}_{SK}} \qquad ( 22 )$$
10. Generate seek trajectories without coast mode using the method described in Section 3.

To demonstrate the application of the above design procedures, we use the extended sinusoidal waveform and the generalized sinusoidal waveform as examples to determine the maximum seek length without coast mode in tracks and its associated maximum seek time in samples.

Table 2 is a comparison table to show the calculations of maximum seek length and corresponding maximum seek time for the generalized sinusoidal waveform without the necessity of a coast mode.

TABLE 2
Maximum Seek Length And Seek Time for Generalized
Sine Waveform without Coast Mode

| Case No | A | ψ | Xₘₐₓ (track) | Nₘₐₓ (sector) |
|---|---|---|---|---|
| 1 | 0.25 | \sqrt{2π} | 82,144 | 352 |
| 2 | 0.20 | 2.3747 | 73,758 | 316 |
| 3 | 0.15 | 2.2617 | 67,076 | 287 |
| 4 | 0.10 | 2.1634 | 61,094 | 262 |
| 5 | 0.05 | 2.0769 | 56,555 | 242 |

Case 1 with A=0.25 reduces the generalized sinusoidal waveform to a sinusoidal wave, which is the slowest waveform in the class.

The second example uses the extended sinusoidal waveform for illustration. The results of five cases studies are summarized in Table 3 below.

TABLE 3
Maximum Seek Length And Seek Time for Extended
Sine Waveform without Coast Mode

| Case No | p | A | Ψ | Xₘₐₓ (track) | Nₘₐₓ (sector) |
|---|---|---|---|---|---|
| 1 | 1.0 | 0.25 | \sqrt{2π} | 82,144 | 352 |
| 2 | 0.9 | 0.1782 | 2.4144 | 76,407 | 327 |
| 3 | 0.8 | 0.1476 | 2.3441 | 71,916 | 308 |
| 4 | 0.5 | 0.0833 | 2.1858 | 62,623 | 268 |
| 5 | 0.3 | 0.0485 | 2.1038 | 57,886 | 248 |

Case 1 with A=0.25 is the reduced form of a sinusoidal wave, which is the slowest waveform in the class of extended sinusoidal waveforms.

3. Seek Trajectories Without Coast Mode

For short to medium seek lengths, there is no coast mode. The seek trajectories, including current, velocity and position, are directly obtained by scaling the normalized seek trajectories. For a given seek length X_{SK}<Xₘₐₓ, the corresponding seek time N_{SK} is less than Nₘₐₓ.

The normalized time axis in these seek trajectories has to be scaled by N_{SK}. The current amplitude is Iₘₐₓ except for very short seek lengths. Therefore, the physical current trajectory to input to VCM is given by

$$I ( n ) = {I}_{max} a ( \frac{n}{{N}_{SK}} ) \qquad ( 23 )$$

Similarly, the physical velocity trajectory and position trajectory for seeks without coast mode are cast in the following.

$$\begin{matrix}V ( n ) = {V}_{SK} v ( \frac{n}{{N}_{SK}} ) & ( 24 ) \\ D ( n ) = {X}_{SK} d ( \frac{n}{{N}_{SK}} ) & ( 25 )\end{matrix}$$

For any of these physical seek trajectories, the discrete time n falls in the range 0≦n≦N_{SK}. The function a(●) in Eq. (23) is the given normalized acceleration waveform as described in Section 1. The waveforms of v(●) in Eq. (24) and d(●) in Eq. (25) are derived from a(●) using any appropriate methods described in Section 1.

It follows from Eq. (8) that the amplitude of velocity V_{SK} in Eq. (24) is related to the velocity amplitude vₘₐₓ of Eq. (19), which is associated with the normalized velocity trajectory v(x).
V_{SK}=vₘₐₓN_{SK} (26)

4. Trajectories for Long Seeks With Coast Mode

When a coast mode is not present, the acceleration trajectory for a seek can be divided into two phases: acceleration phase for a(x)≧0 and deceleration phase for a(x)<0. Previously, we have computed the maximum seek length without coast mode for a given acceleration waveform. When the seek length gets longer than this threshold maximum seek length, a coast mode is inserted to assure the reliable reading of Gray code from disk surface. Now we are going to address the generation of these seek trajectories with a cost mode.

When the seek length X_{SK} is longer than the threshold maximum seek length Xₘₐₓ as computed in previous section, coast mode exists. Let the corresponding seek time be denoted by N_{SK}>Nₘₐₓ, which is the maximum seek length without a coast mode. Then the duration of coast mode is just equal to N_{CST} as follows.
N_{CST}=N_{SK}−Nₘₐₓ (27)

During the duration of coast mode, the normalized acceleration, velocity and position of the transducer are computed as follows, respectively.
a(x)=0 (28)
v(x)=1 (29)
d(x)=dₐ+(x−xₐ) (30)

In Eq. (30), dₐ stands for the displacement at the end of positive acceleration phase, and xₐ is the end time of the acceleration phase. Since the final value of the normalized position trajectory gains a value due to the coast mode as shown in Eq. (30), the resulting position trajectory with coast mode is no longer to have unity maximum displacement. Therefore, we have to normalize the position trajectory again for unity maximum position at the end of seeks. Further, since there is an additional time elapsed due to the coast mode, the time variable in the above equations are normalized with respect to N_{SK} so that x≦1.

Let the normalized seek trajectories of acceleration, velocity and position be denoted by a(x), v(x) and d(x), respectively. These trajectories are generic in the sense that the amplitude and period of each waveform is unity. These trajectories are to be used for any design and for any seek length. Let I(n), V(n) and D(n) be the physical current, velocity and position trajectories, respectively.

These physical seek trajectories for the acceleration phase, namely

$$0 \leq n \leq \frac{{N}_{max}}{2} ,$$

are given as follows.

$$\begin{matrix}I ( n ) = {I}_{max} a ( \frac{n}{{N}_{SK}} ) & ( 31 ) \\ V ( n ) = {V}_{max} v ( \frac{n}{{N}_{SK}} ) & ( 32 ) \\ D ( n ) = {X}_{SK} d ( \frac{n}{{N}_{SK}} ) & ( 33 )\end{matrix}$$

The function a(●) in Eq. (31) is the given normalized acceleration waveform as described in Section 1. The waveforms of v(●) in Eq. (32) and d(●) in Eq. (33) are derived from a(●) using any appropriate methods described in Section 1.

The physical seek trajectories for the deceleration phase, namely

$$\frac{{N}_{max}}{2} + {N}_{CST} < n < {N}_{SK} are$$

given in the following.

$$\begin{matrix}I ( n ) = {I}_{max} a ( \frac{n - \frac{{N}_{max}}{2} - {N}_{CST}}{{N}_{SK}} ) & ( 34 ) \\ V ( n ) = {V}_{max} v ( \frac{n - \frac{{N}_{max}}{2} - {N}_{CST}}{{N}_{SK}} ) & ( 35 ) \\ D ( x ) = {X}_{SK} d ( \frac{n - \frac{{N}_{max}}{2} - {N}_{CST}}{{N}_{SK}} ) & ( 36 )\end{matrix}$$

The function a(●) in Eq. (34) is the given normalized acceleration waveform as described in Section 1. The waveforms of v(●) in Eq. (35) and d(●) in Eq. (36) are derived from a(●) using any appropriate methods described in Section 1.

For the coast mode, these physical seek trajectories for

$$\frac{{N}_{max}}{2} < n \leq \frac{{N}_{max}}{2} + {N}_{CST} are$$

transformed to be the following from Eq. (27) through Eq. (30).

$$\begin{matrix}I ( n ) = 0 & ( 37 ) \\ V ( n ) = {V}_{max} & ( 38 ) \\ D ( n ) = D ( \frac{{N}_{max}}{2} ) + {V}_{max} ( n - \frac{{N}_{max}}{2} ) & ( 39 )\end{matrix}$$

To apply Eq. (39), one needs to convert unit of the design maximum velocity Vₘₐₓ from ips to track per sample.

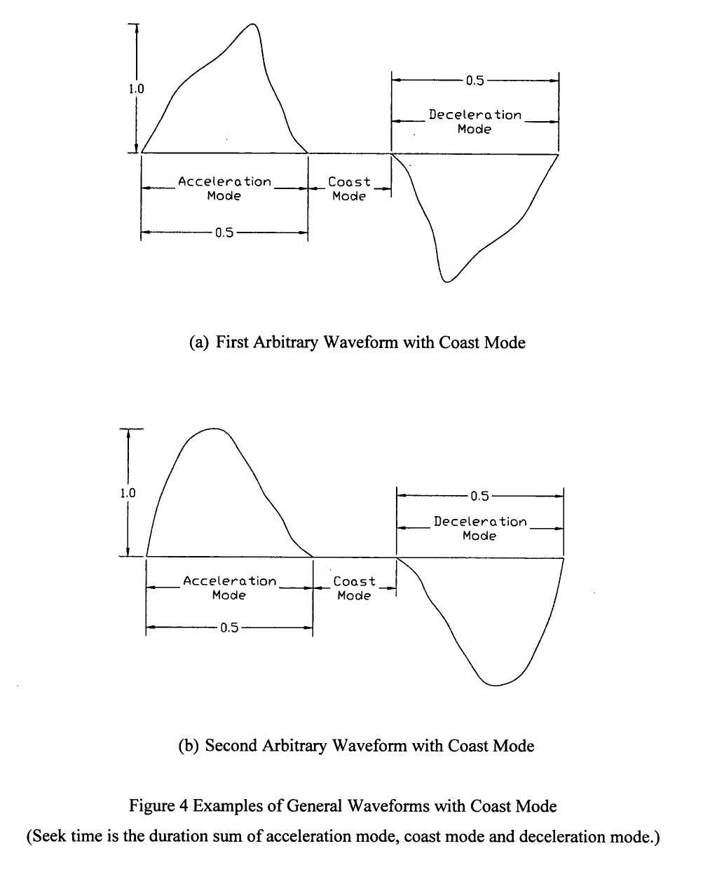

For a given seek length X_{SK}, the procedures to generate the seek trajectories require a serial of computations from Section 2 through Section 4. To clarify the design sequences, the flowchart of FIG. 4 outlines the step-by-step procedures to generate seek trajectories for the given seek length X_{SK} either with coast mode or without coast mode.

5. Controller Design for Seeks

The seek trajectories, including acceleration or current, velocity and position, have been expressed as functions of time. Since the time is a parameter in each design profile, these profiles are referred to as trajectories of the parametric form.

Depending on the design of seek controller, there are two methods to apply the extended sinusoidal wave to seeks in the servomechanism of hard disk drive. The first type seek controller (FIG. 4) is the conventional approach, which relies on the availability of seek trajectories at any instant of servo interrupt. Since these seek profiles are available at any time instant, they are the parametric trajectories.

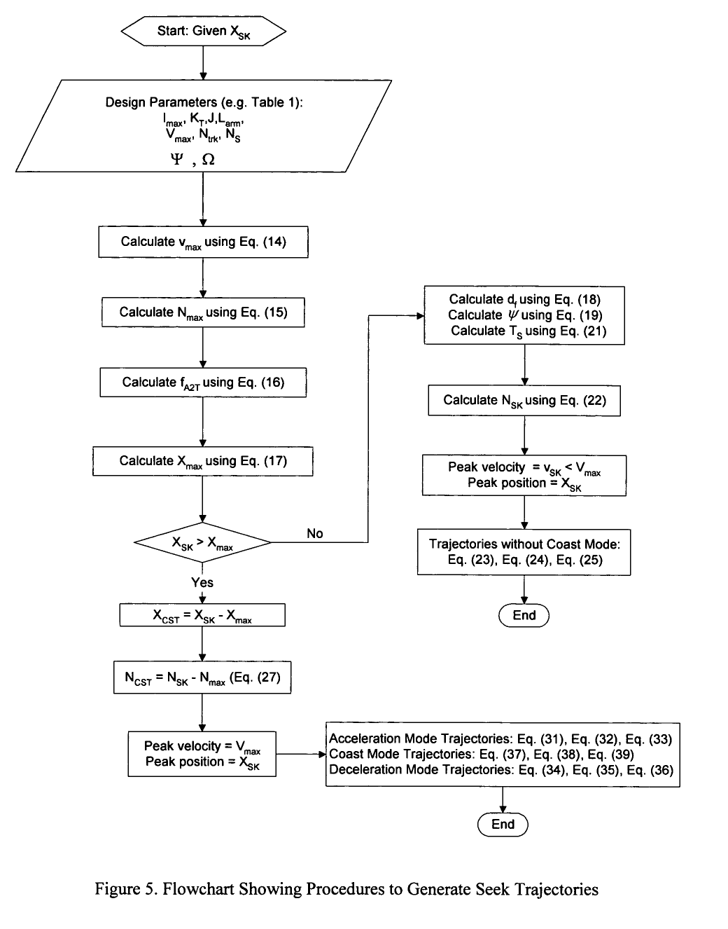

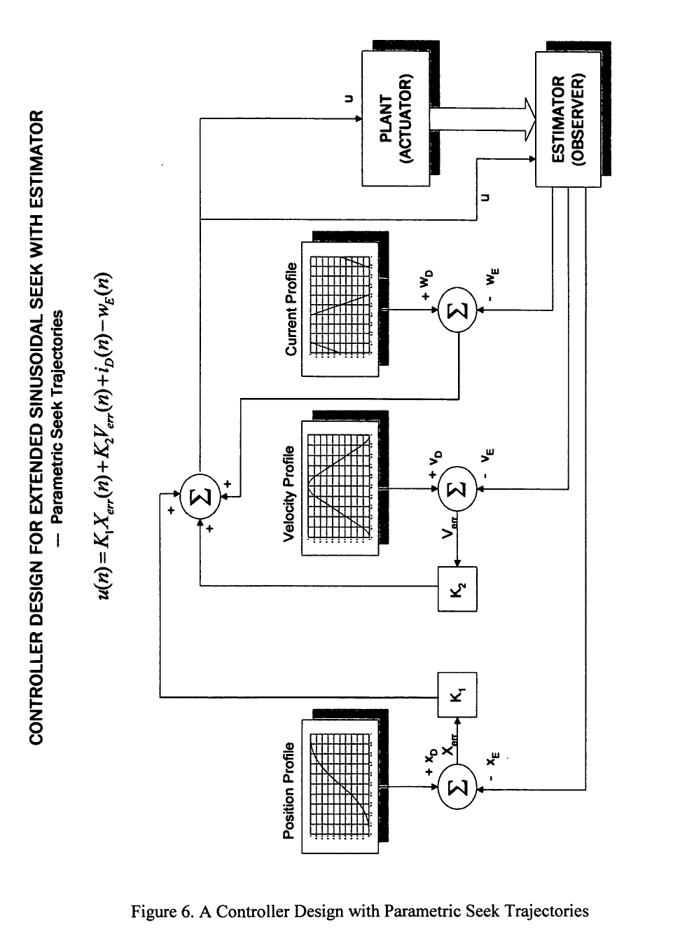

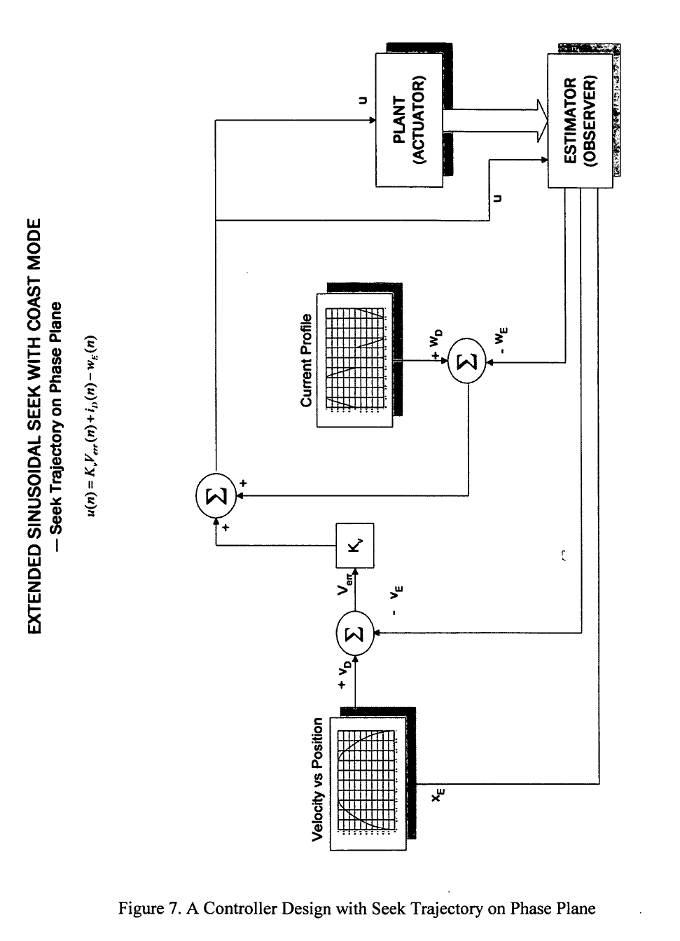

The current trajectory is always given in parametric form because the current input to voice coil motor (VCM) is based on this design trajectory. However, the velocity trajectory and the position trajectory can be combined into a single trajectory on the phase plane by explicitly eliminating the time variable from these trajectories equations. The second type seek controller (FIG. 5) uses the seek trajectory on the phase plane. At any instant of servo interrupt, the head position is measured with a sensor or estimated using an estimator (or observer) when it is available in the servo system design. Given the head position from either the position sensor output or the estimator output, the design velocity at that particular position is extracted from the seek trajectory on the phase plane. The design velocity at that position is then compared against the actual velocity at that instant from either the estimator output or a tachometer output.

Using either one of the two seek controllers, the controller output consists of three parts:
(1) The current corrections associate with the differences between the design velocity and measured velocity, and between the design position and measured position. These error terms are scaled by appropriate gains to yield current corrections.
(2) The design current, which is based on current trajectory at the instant of servo interrupt.
(3) The adjustment current to account for bias caused by flex cable and other possible sources

The control current for the parametric form seek controller (FIG. 4) is given by
u(n)=K₁Xₑᵣᵣ(n)+K₂Vₑᵣᵣ(n)+i_{D}(n)−w_{E}(n) (40)

For seek controller on the phase plane, the controller current (FIG. 5) is computed as follows.
u(n)=K_{V}Vₑᵣᵣ(n)+i_{D}(n)−w_{E}(n) (41)

Note that the parametric trajectories are explicitly dependent on time. The seek trajectory is explicitly dependent on position; however, it is implicitly dependent on time.

6. Multi-Linear Approximation of a Design Curve

The design curve referred herein can be a seek time versus seek length curve, a current trajectory, velocity or a position trajectory. The design curve is continuous over the time range of 0≦n≦N_{SK}, where N_{SK} is the discrete seek time.

In parametric form, there are three seek trajectories, which are current (or acceleration) trajectory, velocity trajectory and position trajectory. These trajectories are function s of an independent variable, which is time. When the time variable is eliminated from the combination of velocity trajectory and position trajectory, the result is a seek trajectory on the phase plane. For implementation, any of these seek trajectories is approximated by a separate multi-linear trajectory (or a piecewise linear trajectory). With the approach of multi-linear approximation, each seek trajectory is divided into a few linear.

With such a method, the seek trajectory is expressed mathematically as follows:

$$y = f ( x ) = \{ \begin{matrix}{C}_{11} x + {C}_{10} , 0 \leq x \leq {x}_{1} , \\ {C}_{21} x + {C}_{20} , {x}_{1} \leq x \leq {x}_{2} , \\ {C}_{31} x + {C}_{30} , {x}_{2} \leq x \leq {x}_{3} , \\ ⋯ \\ {C}_{N 1} x + {C}_{N0} , {x}_{( N - 1 )} \leq x \leq {x}_{N} .\end{matrix} \qquad ( 42 )$$

In the above equation, the variable x is the distance to go in track, and y is the variable associated with a seek trajectory.

A linear line below approximates each segment of the seek trajectory.
yᵢ=Cᵢ₁xᵢ+Cᵢ₀, i=1, 2, . . . , N. (43)

The first coefficient Cᵢ₁ is the slope of the line, and the second coefficient Cᵢ₀ is the intercept of this line.

Suppose that (\overline{x}ᵢ, \overline{y}ᵢ) and (\overline{x}ᵢ₊₁, \overline{y}ᵢ₊₁) are the coordinates of the two end points on the i-th linear trajectory. Then the slope of the i-th linear equations is found to be

$${C}_{i1} = \frac{{\overline{y}}_{i + 1} - {\overline{y}}_{i}}{{\overline{x}}_{i + 1} - {\overline{x}}_{i}} . \qquad ( 44 )$$

The intercept of the i-th linear equations is just equal to the value of function at left end point.
Cᵢ₀=\overline{y}ᵢ. (45)

Equivalently, the intercept of the equation can be determined using Eq. (43) as follows.
Cᵢ₀=\overline{y}ᵢ−Cᵢ₁\overline{x}ᵢ,
Cᵢ₀=\overline{y}ᵢ₊₁−Cᵢ₁\overline{x}ᵢ₊₁. (46)

For implementation consideration, we use the piecewise linear model to represent any of the normalized seek trajectory either in parametric form or on the phase plane. The boundary points x₁, x₂, . . . , x_{N} are pre-determined. Memory storages are used to store three column vectors: {x}, {Cᵢ₁} and {Cᵢ₀}.

In addition to these seek trajectories, the multi-linear approximation is also an ideal method to compute the seek time for a seek length shorter than the threshold maximum seek length without coast mode. When the coast mode is not present, the seek time is proportional to the square root of seek length.

What is claimed is:

1. A hard disk drive, comprising:
(a) a disk which has a surface;
(b) a spindle motor that spins said disk at a constant rotational speed;
(c) a transducer which can write information onto said disk and read information from said disk;
(d) an actuator arm that can move said transducer across said surface of said disk; and,
(e) a controller that controls said actuator arm so that said transducer moves across said disk surface with an acceleration trajectory from a general class of waveform.

2. The disk drive of claim 1, wherein said controller is a digital signal processor.

3. The hard disk drive of claim 2, wherein said digital signal processor controls said actuator arm in accordance with a seek controller algorithm.

4. The hard disk drive of claim 1, wherein said controller performs a servo routine that outputs current to vary the movement of said transducer.

5. The hard disk drive of claim 4, wherein said current is a function of design trajectories and actual position, velocity and bias of the transducer.

6. The hard disk drive of claim 1, wherein said general class of waveform consists of profiles, which are symmetric about the midpoint of each trajectory.

7. The hard drive of claim 5, wherein said design trajectories are acceleration, velocity and position trajectories derived from a given current profile to excite said actuator arm.

8. A method for generating seek trajectories for a controller based on a normalized general acceleration waveform, comprising the steps of:
(a) computing the maximum velocity by integrating the normalized acceleration waveform over one half of period with an appropriate proportional constant;
(b) computing the maximum displacement by integrating the normalized velocity waveform over one full cycle of waveform with an appropriate proportional constant;
(c) computing the maximum seek time for seeks without coast mode;
(d) calculating the conversion factor to transform angular displacement from radian to track;
(e) computing the maximum seek length without a cost mode for the given acceleration waveform;
(f) if seek length is shorter than said maximum seek length without a cost mode, following the procedures from (g) to (k);
(g) calculating the maximum displacement from the position trajectory at the end of seek;
(h) determining the waveform dependent proportional parameter from the maximum displacement of position trajectory;
(i) computing the sampling time of the digital control system;
(j) calculating the maximum seek time for seeks without coast mode;
(k) generating physical seek trajectories without coast mode, including current, velocity and position, where the current amplitude is the design maximum current, and the scale factor for velocity trajectory is the said maximum velocity and the scale factor for position trajectory is equal to the seek length;
(l) if seek length is longer than said maximum seek length without a coast mode, generating physical seek trajectories with coast mode, including current, velocity and position, where the current amplitude is the design maximum current, and the scale factor for velocity trajectory is the said maximum velocity without coast mode and the scale factor for position trajectory is equal to the seek length.

9. The method of claim 8, wherein said maximum displacement is obtained by integrating the normalized velocity trajectory for a full cycle of the wave.

10. The method of claim 8, wherein said maximum seek length without coast mode is the threshold seek length to determine whether a coast mode is present or not.

11. The method of claim 8, wherein said maximum seek time without coast mode is the threshold seek time, which is a function of the said maximum seek length without coast mode of claim 10.

12. The method of claim 8, wherein said maximum seek time without coast mode is the ratio of limit transducer speed to the product of said maximum velocity, actuator arm length and the said sampling time.

13. The method of claim 8, where said maximum seek length without coast mode is proportional to the square of the said maximum seek time without coast mode.

14. The method of claim 8, wherein said maximum seek length without coast mode is proportional to the said maximum displacement.

15. A method for extracting seek time without coast mode and states of seek trajectories for use by a seek controller, comprising the steps of:
(a) approximating the seek time versus seek length curve by a few linear segments, where end points and associated slopes of segments are stored in system memory;
(b) extracting the seek time for a seek length less than the threshold seek length of the waveform from an appropriate linear segment by linear interpolation method;
(c) approximating the current trajectory without coast mode by a few linear segments, where end points and associated slopes of segments are stored in system memory;
(d) approximating the velocity trajectory without coast mode by a few linear segments, where end points and associated slopes of segments are stored in system memory;
(e) approximating the position trajectory without coast mode by a few linear segments, where end points and associated slopes of segments are stored in system memory;
(f) determining the seek states during the coast mode as follows: zero current for current state, constant limit velocity for velocity state and linear displacement plus the end position of the acceleration mode for the position state;
(g) extracting the current state of seek trajectories from an appropriate linear segment by linear interpolation method for seeks without coast mode;
(h) extracting the velocity state of seek trajectories from an appropriate linear segment by linear interpolation method for seeks without coast mode;
(i) extracting the position state of seek trajectories from an appropriate linear segment by linear interpolation method for seeks without coast mode; and,
(j) modifying said current state, velocity state and position state to include the coast mode for long seeks with coast mode.

16. The method of claim 15, wherein said current state for long seeks with coast mode is extracted from a current trajectory consisting three modes: acceleration mode, coast mode and deceleration mode; and the deceleration mode is separated from the acceleration mode by a phase delay of the same current trajectory without coast mode.

17. The method of claim 15, wherein said velocity state for long seeks with coast mode is extracted from a velocity trajectory consisting three modes: acceleration mode, coast mode and deceleration mode; and the deceleration mode is separated from the acceleration mode by a phase delay of the same velocity trajectory without coast mode.

18. The method of claim 15, wherein said position state for long seeks with coast mode is extracted from a position trajectory consisting three modes: acceleration mode, coast mode and deceleration mode; and the deceleration mode is separated from the acceleration mode by a phase delay of the same position trajectory without coast mode.

19. The method of claim 15, wherein said seek controller is a controller using seek trajectories of current, velocity and position in parametric form.

20. The method of claim 15, wherein said seek controller is a controller using seek trajectory on the phase plane, where the seek trajectory is generated combining the velocity trajectory and position trajectory by explicitly eliminating the time factor.
